(19) United States
(12) Patent Application Publication
(10) Pub. No.: US 2026/0078999 A1
(43) Pub. Date: Mar. 19, 2026

(54) OPTICAL MEASUREMENT DEVICE AND METHOD

(71) Applicant: LMI TECHNOLOGIES INC., Burnaby (CA)

(72) Inventor: Heimo KERÄNEN, Oulu (FI)

(21) Appl. No.: 19/131,878

(22) PCT Filed: Jun. 22, 2023
(86) PCT No.: PCT/FI2023/050382

§ 371 Date: May 21, 2025

(51) Int. Cl. G01B 9/02001; G01B 9/02; G01B 9/02097; G01B 11/06

(52) U.S. Cl. CPC G01B 9/02012; G01B 9/02087; G01B 11/0675; G01B 9/02097

(57) ABSTRACT

The invention relates to the field of optical measurement devices, in particular to displacement sensors, 3D sensors for measuring the position and/or shape or thickness of a measurement object. Measurement light is projected onto a measurement object after 5 filtering by a Fabry-Pérot filter such that at each point in a measurement plane, the filtered measurement light has a locally unique wavelength or combination of wavelengths in at least one direction in the measurement plane. Measurement light reflected from the surface of the measurement object is also filtered by a Fabry-Pérot filter in order to filter out measurement light not reflected from the intersection of the measurement object with 0 the measurement plane. To be published with

### TECHNICAL FIELD

The invention relates to the field of optical measurement devices, in particular to displacement sensors, 3D sensors for measuring the position and/or shape or thickness of a measurement object.

### BACKGROUND

In many displacement and 3D profile sensors known in the art, light is projected onto a measurement object and light reflected from the surface of the measurement object is measured in order to determine the shape of the object. The angle of incidence of light on the image sensor in many such devices is offset from zero. Image sensors, such as CCDs and APSs, are not designed to operate at such angles and their performance deteriorates as a result. In triangulation-based devices, the angle of incidence can be reduced by increasing the triangulation angle; however, this strategy is limited by the physical constraints of the system, e.g. it is not possible to increase the triangulation angle to 90 degrees as the sensor would occupy the same space as the measurement object.

Furthermore, increasing the triangulation angle also has the undesirable side effect of increasing shadowing of the reflected light due to changes in the height of the measurement object. The greater the triangulation angle, the lower the change in height that causes shadowing. Furthermore, magnification leading to enlargement of the image causes further rotation of the intermediate image plane, further increasing the angle of incidence of light upon an image sensor if placed on the intermediate image plane, essentially preventing the use of such magnification which may otherwise be useful for improving accuracy of the sensor.

### SUMMARY OF THE INVENTION

A first aspect of the invention related to a sensor for measuring the displacement of a surface of a measurement object relative to the sensor. The sensor comprises:
a light source configured to emit measurement light;
at least one Fabry-Pérot filter;
first optics configured to focus measurement light in a measurement plane, and to focus measurement light reflected from the measurement plane at infinity;
a light sensor; and
second optics for focusing reflected measurement light filtered on the light sensor.

Measurement light emitted from the light source and incident in the measurement plane and reflected measurement light from the measurement plane are filtered by the at least one Fabry-Pérot filter such that at least part of the measurement light reflected from outside the measurement plane is filtered out of the reflected measurement light incident on the light sensor.

An illumination axis extends from the light source to the measurement plane and a measurement axis extends from the measurement plane to the light sensor, and a coaxial portion of the illumination axis and a coaxial portion of the measurement axis may be coaxial adjacent to the measurement plane.

The at least one Fabry-Pérot filter may be located on the coaxial portion and may be tilted relative to the coaxial portion.

The at least one Fabry-Pérot filter may comprise two Fabry-Pérot filters, a first Fabry-Perot filter of the two Fabry-Pérot filters is positioned on the illumination axis outside the coaxial portion of the illumination axis, a second Fabry-Pérot filter of the two Fabry-Pérot filters may be positioned on the measurement axis outside of the coaxial portion of the measurement axis. The angle of the first Fabry-Pérot filter relative to the illumination axis may be equal to the angle of the second Fabry-Pérot filter relative to the measurement axis.

The measurement plane may lie within the focal plane of the first optics.

The light sensor may lie within the focal plane of the second optics.

The sensor may further comprise a beam splitter or split aperture between the light source and at least one Fabry-Pérot filter such that at least part of the measurement light reflected from the measurement plane is transmitted or reflected towards the light sensor.

The first optics may comprise a first optical subset, a diffraction grating, and a second optical subset. The diffraction grating may be positioned in the focal plane of the first optical subset, and measurement light diffracted from the diffraction grating may be focused in the measurement plane by the second optical subset.

The measurement plane and diffraction grating may be tilted with respect to the lens plane of the second optical subset according to the Scheimpflug principle.

Reflected measurement light from the measurement plane may be focused on the diffraction grating by the second optical subset.

The diffraction grating may be a first diffraction grating and the first optics may further comprise a specular reflector, second diffraction grating and third optical subset.

Measurement light from the light source may be incident on a first side of the measurement plane, reflected measurement light received by the second optical subset from the second side of the measurement plane may be focused on the second diffraction grating by the second optical subset, the second diffraction grating may be positioned in the focal plane of the third optical subset such that the third optical subset focuses measurement light diffracted from the second diffraction grating at infinity, and the specular reflector may be configured to reflect reflected measurement light received from a second side of the measurement plane onto the second diffraction grating, or to reflect measurement light diffracted from the first diffraction grating onto the second optical subset.

The diffraction grating may be a first diffraction grating and the first optics may further comprise a second diffraction grating, a beam splitter and combiner, a first reflective surface and a second reflective surface, and a third optical subset. Measurement light from the light source may be incident on the beam splitter and combiner such part of the measurement light is transmitted by the beam splitter and combiner and part of the measurement light is reflected by the beam splitter and combiner, measurement light transmitted by the beam splitter and combiner may be focused onto the first diffraction grating by the first optical subset, measurement light diffracted by the first diffraction grating may be reflected from the first reflective surface such that it enters the second optical subset and is focused in the measurement plane. The second diffraction grating may be positioned in the focal plane of the third optical subset, measurement light reflected by the beam splitter and combiner may be focused onto the second diffraction grating by the third optical subset, and measurement light diffracted by the second diffraction grating may be reflected from the second reflective surface such that it enters the second optical subset and is focused in the measurement plane.

Reflected measurement light from a first side of the measurement plane may be reflected onto the first diffraction grating by the first reflective surface and focused on the first diffraction grating by the second optical subset. Reflected measurement light from a second side of the measurement plane may be reflected onto the second diffraction grating by the second reflective surface and focused on the second diffraction grating by the second optical subset. Reflected measurement light diffracted by the first diffraction grating may be focused at infinity by the first optical subset, reflected measurement light diffracted by the second diffraction grating may be focused at infinity by the third optical subset, and reflected measurement light diffracted by the first diffraction grating and reflected measurement light diffracted by the second diffraction grating may be combined by the beam splitter and combiner such that the combined reflected measurement light is incident on the at least one Fabry-Pérot filter.

When the sensor is in use, the distance from the light sensor to the surface of the measurement object is determined by measuring the location of one or more local intensity maximum of light received at the light sensor.

A second aspect of the invention relates to a method. The method comprises positioning the measurement object at a first position relative to the sensor described above such that the surface of the measurement object intersects the measurement plane, and measuring the intensity of light received by the light sensor.

The method may further comprise repositioning the measurement object from the first position to a second position relative to the sensor, the change in position of the measurement object being defined by a first displacement vector, and measuring the intensity of light received by the light sensor.

The method may further comprise determining the displacement of a first set of one or more points on the surface of the measurement object by identifying the position of one or more intensity peaks of light measured by the light sensor when the measurement object is at the first position.

The method may further comprise determining the displacement of a second set of one or more points on the surface of the measurement object by identifying the position of one or more intensity peaks of light measured by the light sensor when the measurement object is at the second position.

The method may further comprise combining the displacement of the first set of one or more points with the displacement of the second set of one or more points and the first displacement vector to generate a three-dimensional model of the measurement object.

The method may further comprise determining the thickness of a transparent layer of the measurement object by calculating the distance between at least two distinct intensity peaks of light on the light sensor.

A third aspect of the invention relates to use of the sensor described above for measuring the displacement of the surface of a measurement object relative to the sensor, measuring the profile of the measurement object, measuring the three-dimensional shape of the measurement object, and/or measuring a thickness of a transparent layer of the measurement object.

### BRIEF DESCRIPTION OF THE DRAWINGS

FIG. 1 is a schematic drawing of a first optical sensor employing a beam splitter.

FIG. 2 is a schematic drawing of the first optical sensor employing a split aperture.

FIG. 3 is a schematic drawing of a second optical sensor employing a beam splitter.

FIG. 4 is a schematic drawing of the second optical sensor employing a split aperture.

FIG. 5 is a schematic drawing of a third optical sensor.

FIG. 6 is a schematic drawing of a fourth optical sensor.

### DETAILED DESCRIPTION OF THE INVENTION

The invention relates to devices, systems and methods for measuring the displacement of an object relative to a sensor. Such displacement measurements may be used to determine the position, shape and/or thickness of the measurement object or layers thereof. In the sensors of the present invention, measurement light is filtered using a Fabry-Pérot filter before being projected onto the measurement object such that at each point in a measurement plane that intersects the measurement object the measurement light has a locally unique wavelength or combination of wavelengths in the direction of the distance measurement. Measurement light reflected from the surface of the measurement light is then filtered again by the Fabry-Pérot filter in order to filter out or to attenuate measurement light not reflected from the measurement plane. In this context, “filter out” or “attenuate” does not mean the complete removal of measurement light reflected from outside the measurement plane, simply that the intensity of this light is reduced. As explained below, a high-finesse Fabry-Pérot filter more effectively filters out measurement light that is not reflected from the measurement plane, which may lead to a more accurate measurement, but the invention still functions even with a relatively low finesse Fabry-Perot filter or filters.

The basic operation of the sensor and a method for measuring the displacement of an object relative to a sensor, is described with respect to claim 1, but the basic principle of using the Fabry-Pérot filter as described above is the same across all embodiments on the invention.

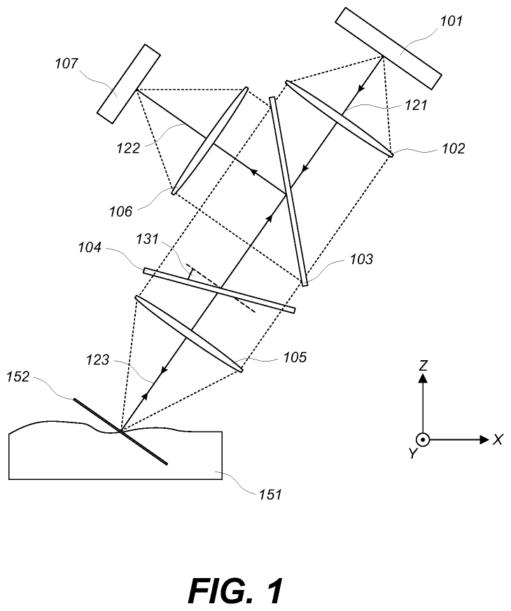

The sensor 100 of FIG. 1 includes a light source 101, which is configured to emit polychromatic measurement light. The emitted measurement light have a relatively narrow bandwidth, or may emit light across a broad spectrum, as long as the spectrum is broad enough to ensure that light can pass through the first Fabry-Pérot filter 104 (as explained in more detail below) at a range of angles. While the term “measurement light” is used throughout this description, it should be understood that the device is not limited to electromagnetic radiation in the visible wavelength range, but may also or alternatively include infrared, ultraviolet or other wavelengths depending on the specific application.

Measurement light emitted by the light source 101 is incident on a first Fabry-Pérot filter 104. The light source 101 is preferably a diffuse area light source, which emits light at a range of angles from each point on its surface. In this way, where measurement light is incident on the first Fabry-Pérot filter 104 it is incident with a range of angles. Light source 101 may be a single light source or multiple light sources. Light source 101 may emit light across the whole area or may include a series of parallel light emitting lines.

In this context, the term “Fabry-Pérot filter” preferably refers to an etalon with a fixed distance between its reflectors, although other types of Fabry-Pérot filters such as tuneable interference filters or interferometers with a tuneable distance between the reflectors may also be used. The wavelengths of light transmitted by a Fabry-Pérot filter are defined by the distance between reflectors l, the refractive index of the material between the reflectors n and the angle of incidence of light on the Fabry-Pérot filter θ. Transmission peaks occur when the optical path length distance of light reflected between the reflectors 2 nl cos θ is an integer multiple of wavelength λ of the incident light. Therefore, for a fixed refractive index n and distance between reflectors l the wavelengths of light transmitted by a Fabry-Pérot interferometer depend on the angle of incidence θ. Therefore, where measurement light is incident on the first Fabry-Pérot filter 104 it is incident with a range of wavelengths such that some of the light incident on the first Fabry-Perot filter 104 at different angles is not completely filtered out by the first Fabry-Pérot filter 104.

Since the angle of incidence of measurement light on the Fabry-Pérot filter and angle of emergence of filtered light are essentially identical, all parallel light filtered by the first Fabry-Pérot filter 104 has the same wavelength of combination of wavelengths of light. As shown in FIG. 1, the normal vector of the first Fabry-Pérot filter 104 is offset by an angle 131 from an illumination axis 121 which extends from the light source 101 to the measurement plane 152.

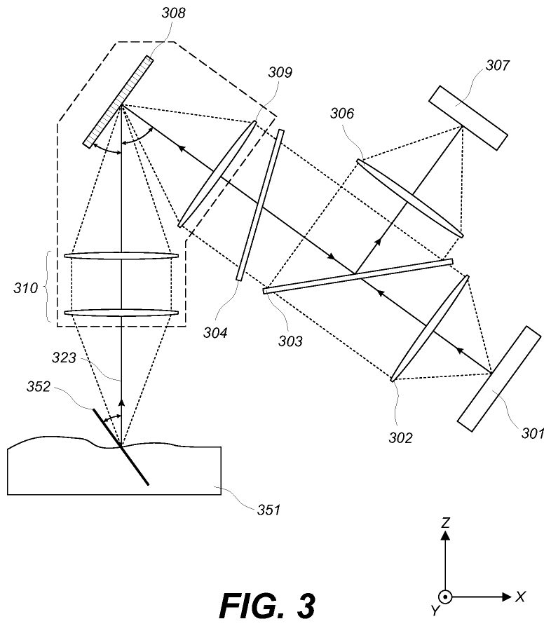

The filtered light is focused through first optics 105 into a measurement plane 152. In the embodiment of FIG. 1, the first optics 105 is a lens, but as depicted in FIG. 3, for example, the first optics may alternatively be compound optics such as a lens assembly.

In all cases, the functionality of the first optics is the same: to focus light filtered by the first Fabry-Pérot filter in the measurement plane. Since all parallel light is focused at the same point in the focal plane of the first optics, i.e. the measurement plane 152, and all parallel light has the same wavelength or combination of wavelengths due to filtering by the Fabry-Pérot filter, all measurement light focused at a given point in the measurement plane 152 has the same wavelength or combination of wavelengths.

Measurement light filtered by the first Fabry-Pérot filter 104 and focused by first optics 105 is reflected from the surface of a measurement object 151. The intensity of the reflected light is greatest at points where the surface of the measurement object 151 intersects the measurement plane 152, i.e. where the measurement light is in focus on the surface of the measurement object 151. Measurement light is typically scattered, i.e. diffusely reflected, from the surface of the measurement object 151. Some of this reflected measurement light is reflected back towards the first optics 105. As a result, measurement light reflected from the measurement plane 152 is focused at infinity by the first optics 105. In other words, all measurement light reflected from a given point on the measurement plane 152 propagates in parallel after passing through the first lens 105.

This reflected measurement light, focused at infinity by the first optics 105, is again incident on the Fabry-Pérot filter 104 in the opposite direction and on the opposite side to unfiltered measurement light emitted by the light source 101. The Fabry-Pérot filter 104 filters out measurement light reflected from any points not within the measurement plane 152. Since all light focused at a given point in the measurement plane 152 has the same wavelength or combination of wavelengths, light rays reflected from the measurement plane 152 and propagating in parallel from the first optics 105 towards the Fabry-Pérot filter 104 have the same wavelength or combination of wavelengths. Furthermore, the angle at which measurement light reflected from the measurement plane propagates is equal to the angle at which light of the same wavelength propagated after the first filtration by the Fabry-Pérot filter 104. Thus, light reflected from the measurement plane 152 that is incident on the Fabry-Pérot filter 104 may pass through the second Fabry-Pérot filter, while light reflected from other parts of the measurement object 151 that do not intersect the measurement plane 152 generally does not propagate in at an angle suitable to pass through the Fabry-Pérot filter 104 and is filtered out by the Fabry-Pérot filter 104.

This arrangement is particularly effective when the wavelength or combination of wavelengths of light in focus at each point in the measurement plane is locally unique in at least one direction in the measurement plane. In other words, the wavelength or combination of wavelengths of light in focus at each point in the measurement is unique amongst points that lie along at least one axis that lies within the measurement plane.

Preferably this axis is parallel to the z-axis shown in the drawings. Put differently, at every point in the measurement plane with the same y-coordinate, a different wavelength or combination of wavelengths of light is in focus.

The performance of the optical sensor 100 for measuring the height of the measurement object 152, i.e. the position on the z-axis at each y-coordinate, is improved when the wavelength or combination of wavelengths of light in focus at each point in the measurement plane 152 is unique amongst points with the same y-coordinate. Thus, it is preferable for the angle 131 of the Fabry Perot filter 104 relative to the illumination axis 131 and relative to total used angle range to be set such that at each point in the measurement plane, the wavelength or the combination of wavelengths of light in focus is unique amongst points with the same y-coordinate. The Fabry-Pérot filter 104 is preferably tilted relative to the illumination axis 121 by rotating the Fabry-Pérot filter about an axis parallel to the measurement plane and perpendicular to the illumination axis 121.

In the drawing of FIG. 1, this is the Y-axis. The offset angle 131 is measured in the Z-X plane, as shown in FIG. 1.

The input angles, i.e. angles of incidence, of light on the first Fabry-Pérot filter 102 may also be restricted to only positive or negative angles to avoid the transmission of light of the same wavelength or combination of wavelengths at two different input angles. Since the illumination axis 121 and measurement axis 122 are coaxial in the region between the Fabry-Pérot filter 104 and the measurement plane 152, a beam splitter 103 is used in the embodiment of FIG. 1 to divert reflected measurement light from the coaxial region 123 towards a light sensor 107. Reflected filtered measurement light that exits the Fabry-Pérot filter 104 is therefore incident on the beam splitter 103 and reflected towards the light sensor 107. Sensor lens 106 focuses reflected measurement light received from the Fabry-Pérot filter 104 in a sensor plane, i.e. in the focal plane of the sensor lens 106.

Again, since the angle of incidence of reflected measurement light on the Fabry-Pérot filter 104 and the angle of emergence of reflected measurement light that passes through the Fabry-Pérot filter 104 are the same, rays of reflected measurement light from a single point on the measurement plane 152 have the same wavelength or combination of wavelengths and propagate towards the sensor lens 106 in parallel and are focused on the same point in the sensor plane.

Light sensor 107, e.g. an image sensor, is positioned in the sensor plane such that its active surface is aligned with the sensor plane and reflected filtered measurement light is in focus on the active surface of the light sensor. The light sensor may be an image sensor such as a CCD (charge-coupled device), CMOS (Complementary metal-oxide-semiconductor) or other APS (active pixel sensor), or a line scan camera.

By measuring the intensity of light received at each point (e.g. each pixel) on the image sensor, the shape of the measurement object 151 at its intersection with the measurement plane 152 can be determined. In particular, measurement light reflected from the intersection of the surface of the measurement object 151 and the measurement plane 152 creates a local maximum of the intensity on the surface of the light sensor 107. The position of the local intensity maximum on the light sensor 107 can be used to determine the distance from the light sensor 107 to each point on the surface of the measurement object 151 from which in-focus measurement light is reflected (i.e. at the intersection of the measurement plane 152 with the measurement object 151), since each point (e.g. pixel) on the light sensor 107 corresponds to a single point in the measurement plane 152 and the position of the measurement plane 152 relative to the light sensor 107 is known.

The position of the measurement plane 152 relative to the light sensor 107 is determined by the optical properties of optical elements located between the measurement plane 152 and the light sensor 107. For example, in the sensor 100, the position of the measurement plane 152 relative to the sensor 107 is determined by the focal length of first optics 105 and the angle of the lens plane of first optics 105 relative to the coaxial portion 123 of the illumination and measurement axes, the angle of the coaxial portion 123 of the illumination and measurement axes relative to the surface of the beam splitter 103, the focal length sensor lens 106 and the angle of the lens plane of the sensor lens 106 relative to the measurement axis 122. This list is not exhaustive.

The image sensor may be physically or logically divided into a plurality of regions, e.g. individual pixels or groups of pixel, each of which is sensitive only to a single wavelength or combination of wavelengths, or a narrow range of wavelengths or combinations of wavelengths.

The sensor 100 may include a light source lens 102, which receives light from the light source 101. In this case, the light source 101 may be positioned outside the focal plane of the light source lens 102 such that measurement light is incident at each point on the Fabry-Pérot filter 104 at multiple angles and so that the potential small inhomogeneities, such as gaps between different individual light source elements, do not cause non-illuminated points on the measurement plane. This may enable a smaller or less diffuse light source to be used, e.g. by placing the light source out of the focal plane of the further lens. If the light source is smaller the angle range of the light source to the collecting lens must be larger in order to get the same angle and power distribution in the first Fabry-Perot filter 102.

The bandwidth of the light source 101 may be restricted to ensure local uniqueness of the wavelengths or combination of wavelengths in focus in the measurement plane and/or the sensor plane based on the offset (tilt) angle 131 of the Fabry-Pérot filter 104 and the input angle range of the Fabry-Pérot filter 104

Restriction of the light source bandwidth may be achieved by using a suitable narrowband light source, such as an LED, or by additionally filtering the light emitted from a broadband light source 101 before it is incident in the measurement plane 152.

Alternatively, where a broadband light source is used, the measurement light may be filtered to an appropriate range of wavelengths at any point between the light source 101 and the sensor 107 in order to ensure local uniqueness of the wavelengths or combination of wavelengths in focus in the sensor plane.

In the sensor 100 of FIG. 1, the Fabry-Pérot filter 104 is located on the coaxial portion 123 of the illumination axis 121 and measurement axis 122. This enables the same Fabry-Perot filter to be used to filter both measurement light from the light source 101 and reflected measurement light from the measurement plane 152, and ensures that the tilt angle of the Fabry-Pérot filter is the same for measurement light from both directions.

However, the single Fabry-Pérot filter 104 may be replaced by two separate Fabry-Pérot filters located on the non-coaxial portions of the illumination axis 121 and measurement axis 122. That is, a first Fabry may be positioned on the illumination axis 121 outside the coaxial portion 123 of the illumination axis, and a second Fabry-Pérot filter may be positioned on the measurement axis 122 outside of the coaxial portion 123 of the measurement axis. In this case, the tilt angle of the first Fabry-Pérot filter relative to the illumination axis 121 is equal to the tilt angle of the second Fabry-Pérot filter relative to the measurement axis 122.

Where two Fabry-Pérot filters are described above, the tilt angles of each Fabry-Pérot filter may be tuned such that measurement light reflected from the measurement plane 152 can pass through the second Fabry-Pérot filter after being filtered by the first. One or both of the tilt angles may be adjusted to ensure the maximum transmission of light through the second Fabry-Pérot filter positioned between the measurement plane and the light sensor 107. Alternatively, where a Fabry-Pérot interferometer or interference filter with a tuneable distance between reflectors is used, this may be used to ensure the correct performance of the device in addition to or instead of adjusting the relative angles of the Fabry-Pérot filters. The use of a fixed etalon is preferable since the angle tuning needs to be performed only once, typically in the manufacturing process. As an example, angular tuning of one or both Fabry-Pérot filters may be achieved by screws which adjust the angle of the Fabry-Pérot filter.

The reflectivity of the reflective surfaces within a Fabry-Pérot filter determines the width of transmission peaks of the Fabry-Pérot filter in the frequency (or wavelength) domain. A Fabry-Pérot filter with narrow transmission peaks, i.e. a high Q-factor, is said to have high finesse. The use of high finesse Fabry-Pérot filters improves the accuracy of the sensor of the present invention since filtering of the measurement light reflected from outside the measurement plane by the Fabry-Pérot filter is improved, leading to a narrower intensity peak on the light sensor.

However, in embodiment that employ two separate Fabry-Pérot filters, narrower transmission peaks of the Fabry-Pérot filters demand more accurate alignment filters to ensure overlap of the desirable transmission peaks. Thus, the ability to precisely tune the angles of the Fabry-Pérot filters, as mentioned above, also allows for high finesse Fabry-Perot filters to be used.

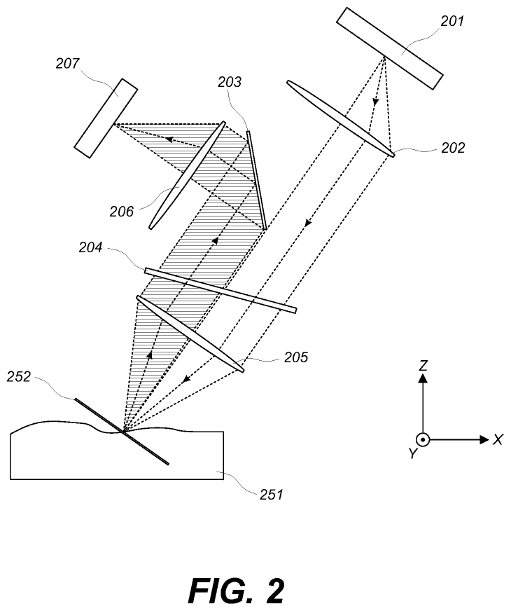

While the sensor 100 of FIG. 1 uses a beam splitter 103 to direct reflected measurement light towards the light sensor 107, any component or arrangement capable of allowing unfiltered measurement light from the light source to reach the Fabry-Pérot filter and diverting reflected measurement light towards the light sensor may be used. For example, in FIG. 2, a split aperture 201 is used instead of the beam splitter 103 of FIG. 1. FIG. 2 depicts a second optical sensor 200, which operates in essentially the same manner as described above with respect to the displacement sensor 100 of FIG. 1. Equivalent features of both devices are denoted by similar reference numerals, e.g. 101 and 201 both indicate the light source as described above. The hatched region shown in FIG. 2 indicate the space in which reflected measurement light propagates from the measurement plane 252 to the light sensor 207, in contrast to the open region in which light propagates from the light source 201 towards the measurement plane 252.

It will also be appreciated that in both embodiments depicted in FIGS. 1 and 2 the arrangement of the illumination axis 121 and measurement axis 122 may be swapped such that unfiltered measurement light is reflected from the beam splitter 103 or split aperture 203 and reflected measurement light propagates directly to the sensor lens 106, 206 and light sensor 107, 207.

FIG. 3 depicts a further sensor 300, which corresponds to the sensor 100 of FIG. 1 in which the first optics 105 of sensor 100 is replaced by first optics 305 in sensor 300.

Equivalent features of both devices are denoted by similar reference numerals, e.g. 101 and 301 both indicate the light source as described above. First optics 305 of sensor 300 is compound optics including a diffraction grating 308, first optical subset 309 and second optical subset 310. The diffraction grating 308 is positioned in the focal plane of the first optical subset 309, and measurement light diffracted from the diffraction grating 308 is focused in the measurement plane 352 by the second optical subset 310. The measurement plane 352 and diffraction grating 308 are tilted with respect to the lens plane of the second optical subset 310 according to the Scheimpflug principle. The use of a diffraction grating in this arrangement allows for the angle of the measurement plane 352 relative to the coaxial portion 323 of the measurement axis to be changed.

The first optical subset 309 may be a simple lens as depicted in FIG. 3 or compound optics. One function of first optical subset 309 is to focus measurement light filtered by the Fabry-Pérot filter 304 onto the surface of diffraction grating 308. Since all parallel light rays emerging from the Fabry-Pérot filter 304 have the same wavelength of combination of wavelengths, all measurement light focused on each point on the surface of the diffraction grating 308 by first optical subset 309 has the same wavelength or combination of wavelengths.

The angle of diffraction θₘ of light from a diffraction grating is determined by the ruling or slit pitch d (also referred to as ruling or slit separation) of the diffraction grating, the wavelength λ of incident light and the angle of incidence θᵢ according to the grating equation d(sin θᵢ−sin θₘ)=±mλ, where m is the mode number m∈ [symbol] ={0, 1, 2, 3 . . . }. The angle of incidence θᵢ and angles of diffraction θₘ are defined in opposite directions relative to a plane parallel to the diffraction grating's rulings or slits and extending perpendicular to the planar surface of the diffraction grating, also referred to as the grating normal.

Filtered measurement light is diffracted from the surface of the diffraction grating 308 towards second optical subset 310. Second optical subset 310 focuses light diffracted from the surface of the diffraction grating 308 in the measurement plane 352. In other words, for the optical system consisting of the diffraction grating 308, second optical subset 310 and the measurement plane 352, the diffraction grating 308 lies in the subject plane, the lens plane is defined by the second optical subset 310, and the measurement plane 352 lies in the image plane as defined by the Scheimpflug principle.

Measurement light reflected from the surface of the measurement object 352 is received by the second optical subset 310 and focused onto the surface of the diffraction grating 308. Reflected measurement light diffracted by the diffraction grating 308 is then received by the first optical subset 309, which focuses the reflected measurement light that is in focus on the surface of the diffraction grating 308 at infinity.

Since the angle of diffraction of light from the diffraction grating 308 is not necessarily the same as the angle of incidence, by selecting an appropriate diffraction grating and wavelength range of measurement light, the angle of the measurement plane 352 can be changed relative to the coaxial portion 323 of the illumination axis. Where the sensor of the present invention is used measuring the three-dimensional shape of a measurement object, the measurement object is moved through the measurement plane parallel to the X-axis shown in the drawings in order to sample its surface at multiple X positions. For sensors 100 and 200 of FIGS. 1 and 2, in which the measurement plane is perpendicular to the coaxial portion 123 of the illumination axis, the coaxial portion 123 of the illumination and measurement axes has to be tilted relative to the Z axis in order for the measurement object to intersect the measurement planes 152, 252 at different Z positions. This means that large changes in height of the measurement object can lead to shadowing of parts of the surface of the measurement object, which will never be measured. In contrast, in the sensor 300 of FIG. 3, the coaxial portion 323 of the illumination and measurement axes can be arranged parallel to the Z axis such that high aspect ratio features (i.e. features on the surface of the measurement object with a large change in height) do not cause shadowing.

FIG. 3 depicts diffraction grating 308 as a reflective diffraction grating, but transmissive a diffraction grating may also be used.

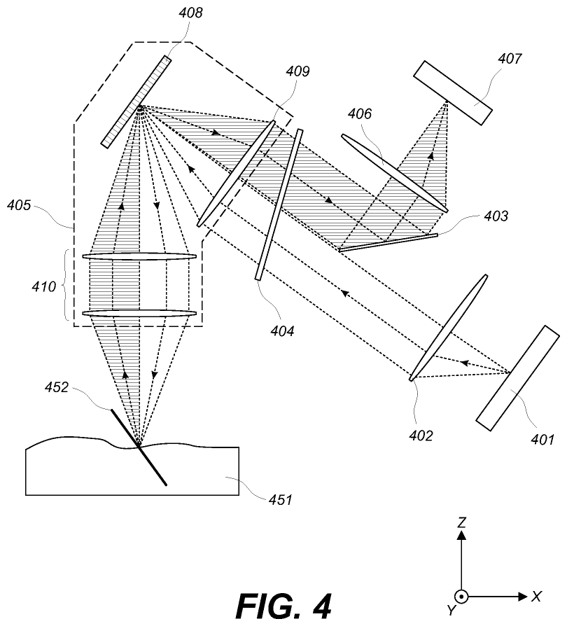

FIG. 4 depicts an alternative sensor 400 in which the beam splitter 303 of the sensor 300 is replaced by a split aperture 403. Equivalent features of both devices are denoted by similar reference numerals, e.g. 301 and 401 both indicate the light source as described above. The split aperture 403 of FIG. 4 functions in the same way as described above with respect to the split aperture 203 of FIG. 2.

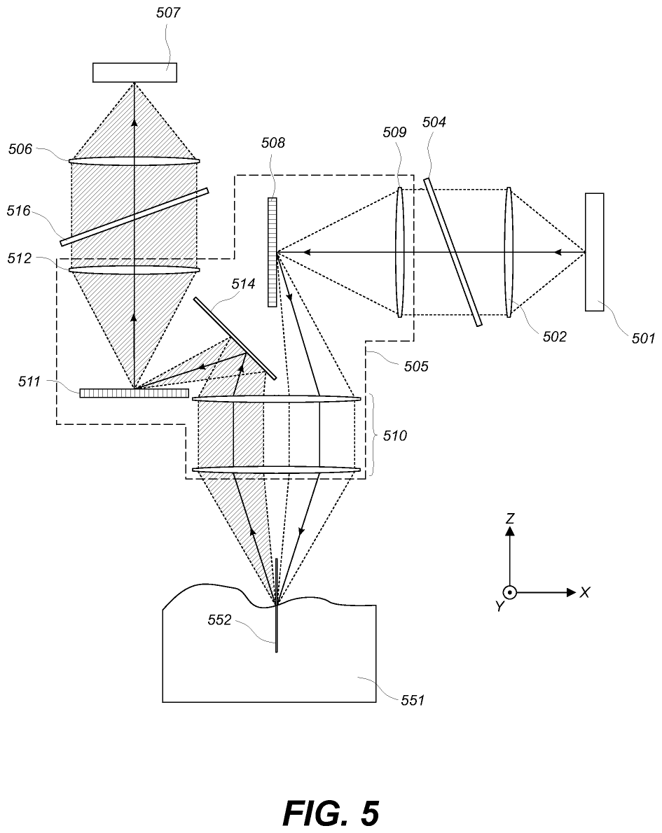

FIG. 5 shows an further sensor 500 in which a separate Fabry-Pérot filter is provided on each of the illumination and measurement axes, as described above with respect to FIG. 1. Equivalent features of both sensors 100 and 500 are denoted by similar reference numerals, e.g. 101 and 501 both indicate the light source as described above.

As in sensors 300 and 400, the first optics 505 of sensor 500 is a compound optical system as opposed to a simple lens as shown in FIG. 1. The illumination mode of sensor 500 functions in essentially the same way as in sensors 300 and 400. The first optical subset 509 may be a simple lens as depicted in FIG. 5 or compound optics. The function of first optical subset 509 is to focus measurement light filtered by the Fabry-Perot filter 504 onto the surface of diffraction grating 508. Since all parallel light rays emerging from the Fabry-Pérot filter 504 have the same wavelength of combination of wavelengths, all measurement light focused on each point on the surface of the diffraction grating 508 by first optical subset 509 has the same wavelength or combination of wavelengths. Filtered measurement light is diffracted from the surface of the diffraction grating 508 towards second optical subset 510. Second optical subset 510 focuses light diffracted from the surface of the diffraction grating 508 in the measurement plane 552. In other words, for the optical system consisting of the diffraction grating 508, second optical subset 510 and the measurement plane 552, the diffraction grating 508 lies in the subject plane, the lens plane is defined by the second optical subset 510, and the measurement plane 552 lies in the image plane as defined by the Scheimpflug principle.

Measurement light reflected from the measurement plane 552 is received by the second optical subset 510 and focused onto a second diffraction grating 511 via a specular reflector 514. The specular reflector 514 acts as a split aperture, allowing measurement light in the illumination mode to enter the second optical subset 510 while diverting reflected measurement light exiting the second optical subset 510 towards the second diffraction grating 511. Reflected measurement light diffracted by the second diffraction grating 511 is then received by the a third optical subset 512, which focuses the reflected measurement light that is in focus on the surface of the second diffraction grating 511 at infinity.

In an alternative arrangement, the specular reflector 514 may instead be positioned such that light diffracted from the first diffraction grating 508 is reflected by the specular reflector 514 onto the second optical subset 510.

Reflected measurement light exiting the third optical subset 512 is incident upon the second Fabry-Pérot filter 516, which is arranged with the same tilt angle relative to the measurement axis extending from the second diffraction grating 511 to the light sensor 507 as the tilt angle of the first Fabry-Pérot filter 504 relative to the illumination axis extending from the light source 501 to the first diffraction grating 508. In this way, the second Fabry-Pérot filter 516 filters out or attenuates measurement light reflected from any points not within the measurement plane 552.

As shown in FIG. 5, the measurement plane 552 may be aligned with the surface of the first diffraction grating 508, i.e. the measurement plane 552 and the surface of the diffraction grating 508 are parallel. Furthermore, the measurement plane 552 is aligned with the Z-axis. This arrangement prevents most shadowing of the measurement light by high aspect ratio features on the surface of a measurement object 551, but it is not essential.

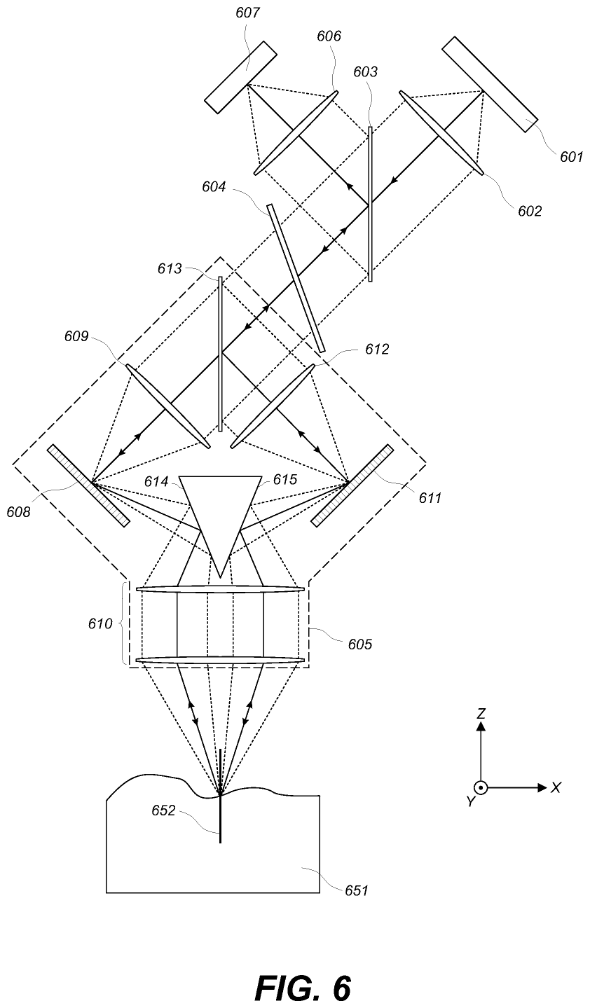

A further sensor 600 depicted in FIG. 6 corresponds to the sensors 100, 200, 300 and 400 depicted in FIGS. 1 to 4 in that it employs a single Fabry-Pérot filter 604 located on a coaxial portion of the illumination and measurement axes. However, like the sensors 100, 200, 300 and 400, it will be understood that the single Fabry-Pérot filter 604 may be replaced by separate Fabry-Pérot filters located on the illumination and measurement axes outside of the coaxial region. Like all of the other figures described above, equivalent features of sensor 600 with those depicted in in other figures are denoted by similar reference numerals, e.g. 101, 201, 301, 401, 501 and 601 all indicate the light source as described above.

In sensor 600, the first optics 605 includes first optical subset 609, first diffraction grating 608, second optical subset 610, second diffraction grating 611 and third optical subset 612, second diffraction grating (611). The first optics 605 also include a beam splitter and combiner 613, a first reflective surface 614 and a second reflective surface 615. The first and second reflective surfaces 614 and 615 are specular reflectors and may be part of a single component having multiple reflective surfaces as shown in FIG. 6, or may be separate reflectors.

Measurement light from the light source 601 and filtered by the Fabry-Pérot filter 604 is incident on the beam splitter and combiner 613 such part of the measurement light is transmitted by the beam splitter and combiner 613 along a first optical path towards first optical subset 609 and part of the measurement light is reflected by the beam splitter and combiner along a second optical path towards third optical subset 612.

Measurement light transmitted by the beam splitter and combiner 613 along the first optical path is focused onto the first diffraction grating 608 by the first optical subset 609.

Measurement light diffracted by the first diffraction grating 608 is then reflected from the first reflective surface 614 such that it enters the second optical subset 610 and is focused in the measurement plane 652. The first diffraction grating 608 first reflective surface 614, second optical subset 610 and measurement plane 652 are arranged according to the Scheimpflug principle such that the first diffraction grating 608 lies in the subject plane, the lens plane is defined by the second optical subset 610, and the measurement plane 652 lies in the image plane.

Measurement light reflected by the beam splitter and combiner 613 along the second optical path is focused onto the second diffraction grating 611 by the third optical subset 612. Measurement light diffracted by the second diffraction grating 611 is then reflected from the second reflective surface 615 such that it enters the second optical subset 610 and is focused in the measurement plane 652. The second diffraction grating 611, second reflective surface 615, second optical subset 610 and measurement plane 652 are arranged according to the Scheimpflug principle such that the second diffraction grating 611 lies in the subject plane, the lens plane is defined by the second optical subset 610, and the measurement plane 652 lies in the image plane.

When measurement light is reflected from the measurement plane, some of it is reflected back towards the second optical subset 610. Reflected measurement light that exits the second optical subset 610 and is reflected from the first reflective surface 614 is focused onto the surface of the first diffraction grating 608 by the second optical subset 610.

Reflected measurement light that exits the second optical subset 610 and is reflected from the second reflective surface 615 is focused onto the surface of the second diffraction grating 611 by the second optical subset.

Reflected measurement light focused onto the first diffraction grating 608 is diffracted from the first diffraction grating 608 and enters the first optical subset 609, which focuses the reflected measurement light reflected from the measurement plane at infinity. Similarly, reflected measurement light focused onto the second diffraction grating 611 is diffracted from the second diffraction grating 611 and enters the third optical subset 612, which focuses the reflected measurement light reflected from the measurement plane at infinity.

The measurement light reflected from the measurement plane and focused by the first optical subset 609 and the third optical subset 612 is combined by beam splitter and combiner 613 and propagates towards the Fabry-Pérot filter 604. Reflected measurement light incident on the Fabry-Pérot filter 604 is filtered by the Fabry-Pérot filter such that only measurement light reflected from the measurement plane 652 is transmitted.

The other components of sensor 600 work in the same way as described above with respect to FIGS. 1 to 4.

It is important that the first and second optical paths have the same path length since measurement light is split and recombined after being reflected from the measurement plane 652.

Any of the displacement sensors described above may be used in a three-dimensional sensor for measuring the three-dimensional shape of the measurement object. By imaging the measurement light projected onto the measurement object at multiple positions on the measurement object, a three-dimensional model of the measurement object can be constructed. In practice, displacement measurements are repeatedly or continuously made as the measurement object moves through the measurement plane, which may be achieved either by moving the sensor relative to a stationary measurement object, or by moving the measurement object relative to the sensor, e.g. on a conveyor belt. Each measurement can be seen as measuring the profile of a cross-sectional slice of the measurement object, and the three-dimensional shape of the measurement object can be reconstructed from these profile measurements by combining them with the known displacement between each measurement.

The sensors may also be used also for multilayer measurement, for example for measuring thicknesses of transparent films. Reflection of the measurement light from the surface of each layer of the transparent film produces a distinguishable intensity peak, and when the refractive indices of the layers are known, the thickness can be calculated based on the distance between two subsequent peaks on the light sensor.

Furthermore, where the light sensor is an image sensor such as a CCD or APS, such as a CMOS sensor, the light sensors may also capture conventional 2D images of the surface of the measurement object while simultaneously measuring the displacement as described above.

1. A sensor for measuring the displacement of a surface of a measurement object relative to the sensor, the sensor comprising:
a light source configured to emit measurement light;
at least one Fabry-Pérot filter;
first optics configured to focus measurement light in a measurement plane, and to focus measurement light reflected from the measurement plane at infinity;
a light sensor; and
second optics for focusing reflected measurement light filtered on the light sensor;
wherein measurement light emitted from the light source and incident in the measurement plane and reflected measurement light from the measurement plane are filtered by the at least one Fabry-Pérot filter such that at least part of the measurement light reflected from outside the measurement plane is filtered out of the reflected measurement light incident on the light sensor.

2. The sensor of claim 1, wherein an illumination axis extends from the light source to the measurement plane and a measurement axis extends from the measurement plane to the light sensor, and wherein a coaxial portion of the illumination axis and a coaxial portion of the measurement axis are coaxial adjacent to the measurement plane.

3. The sensor of claim 2, wherein the at least one Fabry-Pérot filter is located on the coaxial portion and is tilted relative to the coaxial portion.

4. The sensor of claim 2, wherein the at least one Fabry-Pérot filter comprises two Fabry-Pérot filters, a first Fabry-Pérot filter is positioned on the illumination axis outside the coaxial portion of the illumination axis, a second Fabry-Perot filter is positioned on the measurement axis outside of the coaxial portion of the measurement axis, and wherein the angle of the first Fabry-Pérot filter relative to the illumination axis is equal to the angle of the second Fabry-Pérot filter relative to the measurement axis.

5. The sensor of claim 1, wherein the measurement plane lies within the focal plane of the first optics.

6. The sensor of claim 1, wherein the light sensor lies within the focal plane of the second optics.

7. The sensor of claim 1, wherein the sensor further comprises a beam splitter or split aperture between the light source and at least one Fabry-Pérot filter such that at least part of the measurement light reflected from the measurement plane is transmitted or reflected towards the light sensor.

8. The sensor of claim 1, wherein the first optics comprises a first optical subset, a diffraction grating, and a second optical subset, wherein the diffraction grating is positioned in the focal plane of the first optical subset, and wherein measurement light diffracted from the diffraction grating is focused in the measurement plane by the second optical subset.

9. The sensor of claim 8, wherein the measurement plane and diffraction grating are tilted with respect to the lens plane of the second optical subset according to the Scheimpflug principle.

10. The sensor of claim 8, wherein reflected measurement light from the measurement plane is focused on the diffraction grating by the second optical subset.

11. The sensor of claim 8, wherein the diffraction grating is a first diffraction grating and the first optics further comprises a specular reflector, second diffraction grating and third optical subset, wherein:
measurement light from the light source is incident on a first side of the measurement plane;
reflected measurement light received by the second optical subset from the second side of the measurement plane is focused on the second diffraction grating by the second optical subset;
the second diffraction grating is positioned in the focal plane of the third optical subset such that the third optical subset focuses measurement light diffracted from the second diffraction grating at infinity; and
the specular reflector is configured to reflect reflected measurement light received from a second side of the measurement plane onto the second diffraction grating, or to reflect measurement light diffracted from the first diffraction grating onto the second optical subset.

12. The sensor of claim 8, wherein the diffraction grating is a first diffraction grating and the first optics further comprises a second diffraction grating, a beam splitter and combiner, a first reflective surface and a second reflective surface, and a third optical subset, wherein:
measurement light from the light source is incident on the beam splitter and combiner such part of the measurement light is transmitted by the beam splitter and combiner and part of the measurement light is reflected by the beam splitter and combiner;
measurement light transmitted by the beam splitter and combiner is focused onto the first diffraction grating by the first optical subset;
measurement light diffracted by the first diffraction grating is reflected from the first reflective surface such that it enters the second optical subset and is focused in the measurement plane;
the second diffraction grating is positioned in the focal plane of the third optical subset and measurement light reflected by the beam splitter and combiner is focused onto the second diffraction grating by the third optical subset;
measurement light diffracted by the second diffraction grating is reflected from the second reflective surface such that it enters the second optical subset and is focused in the measurement plane.

13. The sensor of claim 12, wherein:
reflected measurement light from a first side of the measurement plane is reflected onto the first diffraction grating by the first reflective surface and focused on the first diffraction grating by the second optical subset;
reflected measurement light from a second side of the measurement plane is reflected onto the second diffraction grating by the second reflective surface and focused on the second diffraction grating by the second optical subset;
reflected measurement light diffracted by the first diffraction grating is focused at infinity by the first optical subset;
reflected measurement light diffracted by the second diffraction grating is focused at infinity by the third optical subset; and
reflected measurement light diffracted by the first diffraction grating and reflected measurement light diffracted by the second diffraction grating are combined by the beam splitter and combiner such that the combined reflected measurement light is incident on the at least one Fabry-Pérot filter.

14. The sensor of claim 1, wherein when the sensor is in use, the distance from the light sensor to the surface of the measurement object is determined by measuring the location of one or more local intensity maximum of light received at the light sensor.

15. A method for measuring a displacement of a surface of a measurement object, the method comprising:
providing a light source configured to emit measurement light;
providing at least one Fabry-Pérot filter;
providing first optics configured to focus measurement light in a measurement plane, and to focus measurement light reflected from the measurement plane at infinity;
providing a light sensor;
providing second optics configured to focus reflected measurement light filtered on the light sensor,
wherein measurement light emitted from the light source and incident in the measurement plane and reflected measurement light from the measurement plane are filtered by the at least one Fabry-Pérot filter such that at least part of the measurement light reflected from outside the measurement plane is filtered out of the reflected measurement light incident on the light sensor;
positioning the measurement object at a first position relative to the light sensor such that the surface of the measurement object intersects the measurement plane; and
measuring the intensity of light received by the light sensor.

16. The method of claim 15, wherein the method further comprises:
repositioning the measurement object from the first position to a second position relative to the light sensor, wherein the change in position of the measurement object is defined by a first displacement vector; and
measuring the intensity of light received by the light sensor.

17. The method of claim 15, wherein the method further comprises determining the displacement of a first set of one or more points on the surface of the measurement object by identifying the position of one or more intensity peaks of light measured by the light sensor when the measurement object is at the first position.

18. The method of claim 17, wherein the method further comprises determining the displacement of a second set of one or more points on the surface of the measurement object by identifying the position of one or more intensity peaks of light measured by the light sensor when the measurement object is at the second position.

19. The method of claim 18, wherein the method further comprises combining the displacement of the first set of one or more points with the displacement of the second set of one or more points and the first displacement vector to generate a three-dimensional model of the measurement object.

20. The method of claim 16, wherein the method further comprises determining the thickness of a transparent layer of the measurement object by calculating the distance between at least two distinct intensity peaks of light on the light sensor.

21. A method for measuring a displacement of a surface of a measurement object, the method comprising:
providing a light source configured to emit measurement light;
providing at least one Fabry-Pérot filter;
providing first optics configured to focus measurement light in a measurement plane, and to focus measurement light reflected from the measurement plane at infinity;
providing a light sensor;
providing second optics configured to focus reflected measurement light filtered on the light sensor,
wherein measurement light emitted from the light source and incident in the measurement plane and reflected measurement light from the measurement plane are filtered by the at least one Fabry-Pérot filter such that at least part of the measurement light reflected from outside the measurement plane is filtered out of the reflected measurement light incident on the light sensor;
measuring the displacement of the surface of a measurement object relative to the light sensor,
measuring the profile of the measurement object,
measuring the three-dimensional shape of the measurement object, and/or measuring a thickness of a transparent layer of the measurement object.
